(19) United States
(12) Patent Application Publication
(10) Pub. No.: US 2021/0256085 A1
(43) Pub. Date: Aug. 19, 2021

(54) METHODS AND DEVICES FOR SEARCHING FOR A HOSTED APPLICATION

(71) Applicant: SHANGHAI ZHANGMEN SCIENCE AND TECHNOLOGY CO., LTD., Shanghai (CN)

(72) Inventors: Yong SU, Shanghai (CN); Fei WANG, Shanghai (CN)

(21) Appl. No.: 17/214,929

(22) Filed: Mar. 29, 2021

Related U.S. Application Data
(63) Continuation of application No. PCT/CN2019/108509, filed on Sep. 27, 2019.

(30) Foreign Application Priority Data
Sep. 30, 2018 (CN) 201811159084.8

(51) Int. Cl. G06F 16/9538; G06F 16/951

(52) U.S. Cl. CPC G06F 16/9538; G06F 16/951

(57) ABSTRACT

A method for searching for a hosted application is described. The method includes establishing or updating a hosted application index information library for a plurality of hosted applications, and hosted applications are stored or registered at the first network device. The hosted application index information library includes hosted application records, and each of the hosted application records corresponds to one of the hosted applications and includes hosted application information and an index field of the hosted application, receiving a hosted application search request transmitted by a user equipment, searching for a match in the hosted application index information library according to the hosted application search request to obtain information on one or more target hosted applications which match the hosted application search request, and returning information on at least one of the one or more target hosted applications to the user equipment.

### CROSS REFERENCE TO THE RELATED APPLICATION

This application is the continuation application of International Application No. PCT/CN2019/108509, filed on Sep. 27, 2019, which is based upon and claims priority to Chinese Patent Application No. 201811159084.8, filed on Sep. 30, 2018, the entire contents of which are incorporated herein by reference.

### FIELD

The present application relates to communication, and more particularly relates to a technology for searching for a hosted application.

### BACKGROUND

A hosted application is an application which can be used without downloading and installing and is a new form of application. Usually, a hosted application is logged in with aid of and in conjunction with other platforms, such as WeChat, Alipay, etc., and accesses background user data from an application which has been developed by a developer without direct jump between the hosted application and the corresponding application. A user may experience a hosted application developed by a developer through QR code, search, etc. A user equipment of the user obtains executable codes of a target hosted application through a communication connection with other platforms, and to establish a communication connection with a hosted application server and thus experience functions of the hosted application. Currently, other platforms which are in cooperative with the hosted application generally save only executable codes and brief description information of the hosted application. The user must enter a name of the hosted application to obtain target hosted application information when searching.

### SUMMARY

An embodiment of the present application is to provide a method and a device for searching for a hosted application.

According to an aspect of the present application, it is provided a method for searching for a hosted application at a first network device. The method comprises:

establishing or updating a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application;

receiving a hosted application search request transmitted by a user equipment;

searching for a match in the hosted application index information library according to the hosted application search request to obtain information on one or more target hosted applications which match the hosted application search request; and

returning information on at least one of the one or more target hosted applications to the user equipment.

According to another aspect of the present application, it is provided a method for searching for a hosted application. The method comprises:

receiving a hosted application search request transmitted by a user equipment;

determining one or more corresponding hosted application search interfaces according to the hosted application search request;

transmitting the hosted application search request to a second network device corresponding to each of the hosted application search interfaces through the one or more hosted application search interfaces, and receiving one or more pieces of search response information returned by the second network device; and

returning information on at least one of one or more corresponding target hosted applications to the user equipment, and information on each of the target hosted applications comprises at least one of the one or more pieces of search response information returned by the corresponding second network device.

According to an aspect of the present application, it is provided a first network device for searching for a hosted application. The device comprises:

a processor; and

a memory arranged to store computer executable instructions, and the executable instructions, when executed, cause the processor to:
establish or update a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application;
receive a hosted application search request transmitted by a user equipment;
search for a match in the hosted application index information library according to the hosted application search request to obtain information on one or more target hosted applications which match the hosted application search request; and
return information on at least one of the one or more target hosted applications to the user equipment.

According to another aspect of the present application, it is provided a first network device for searching for a hosted application. The device comprises:

a processor; and

a memory arranged to store computer executable instructions, and the executable instructions, when executed, cause the processor to:

receive a hosted application search request transmitted by a user equipment;

determine one or more corresponding hosted application search interfaces according to the hosted application search request;

transmit the hosted application search request to a second network device corresponding to each of the hosted application search interfaces through the one or more hosted application search interfaces, and receive one or more pieces of search response information returned by the second network device; and

return information on at least one of one or more corresponding target hosted applications to the user equipment, and information on each of the target hosted applications comprises at least one of the one or more pieces of search response information returned by the corresponding second network device.

According to an aspect of the present application, it is provided a computer readable medium comprising instructions, and the instructions, when executed, cause a system to:

establish or update a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application;

receive a hosted application search request transmitted by a user equipment;

search for a match in the hosted application index information library according to the hosted application search request to obtain information on one or more target hosted applications which match the hosted application search request; and

return information on at least one of the one or more target hosted applications to the user equipment.

According to another aspect of the present application, it is provided a computer readable medium comprising instructions, and the instructions, when executed, cause a system to:

receive a hosted application search request transmitted by a user equipment;

determine one or more corresponding hosted application search interfaces according to the hosted application search request;

transmit the hosted application search request to a second network device corresponding to each of the hosted application search interfaces through the one or more hosted application search interfaces, and receive one or more pieces of search response information returned by the second network device; and

return information on at least one of one or more corresponding target hosted applications to the user equipment, and information on each of the target hosted applications comprises at least one of the one or more pieces of search response information returned by the corresponding second network device.

Compared with the prior art, the present application comprises establishing a hosted application index information library at the first network device, and hitting information on one or more corresponding target hosted applications when a user searches for a hosted application, which improves efficiency of searching hosted applications and hit rate of matching hosted applications, and greatly enhances use efficiency of users. Moreover, the target hosted application information obtained by the user according to the search request comprises both identification information on the target hosted application and page contents or link information of the page contents related to the hosted applications, such as page URLs, and the search range is broader and the search result is more accurate, which improves users' search experience and helps users to obtain the required information quickly and accurately.

In addition, the present application may also comprises transmitting, at the first network device, the search request to the second network device through the search interface when the search request is received from the user, and obtaining corresponding search result information. The search result information obtained by the method in real time comprises page contents related to the hosted application, which can help the user to make synthetic judgment of search results more comprehensively, provide richer reference contents for the user to choose the target hosted application, and greatly enhance use experience of the user.

### DESCRIPTIONS OF THE DRAWINGS

Embodiments of the present application will become more apparent by reading the detailed description of non-limiting embodiments with reference to the following drawings:

FIG. 1 shows a topology diagram of a system for searching for a hosted application according to an embodiment of a first aspect of the present application;

FIG. 2 shows a flowchart of a method for searching for a hosted application at a first user equipment according to an embodiment of a second aspect of the present application;

FIG. 3 shows a flowchart of a method for searching for a hosted application at a first user equipment according to an embodiment of a third aspect of the present application;

FIG. 4 shows a equipment structure diagram of a first user equipment for searching for a hosted application according to an embodiment of a fourth aspect of the present application;

FIG. 5 shows a equipment structure diagram of a first user equipment for searching for a hosted application according to an embodiment of a fifth aspect of the present application; and

FIG. 6 shows an exemplary system which may be used to implement the various embodiments described in the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (e.g., Central Processing Units, CPUs), an input/output interface, a network interface and a memory.

The memory may include a non-permanent memory, a random access memory (RAM) and/or a non-volatile memory and the like in a computer-readable medium, such as a read-only memory (ROM) or a flash memory. A memory is an example of a computer-readable medium.

A computer-readable medium comprises permanent and non-permanent, movable and a non-movable medium and may implement information storage by means of any method or technology. Information may be computer-readable instructions, data structures, program devices or other data. The examples of a computer storage medium include but are not limited to a phase-change memory (PCM), a programmable random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disk read-only memory (CD-ROM), a digital versatile disc (DVD) or other optical storages, a magnetic cassette tape, and magnetic tape and magnetic disk storage or other magnetic storage devices or any other non-transmission medium, which can be used to store information that can be accessed by a computing device.

The devices referred to in the present application include, but are not limited to, user equipments, network devices, or devices formed by the integration of user equipments and network devices through a network. User equipments include but are not limited to any type of mobile electronic products for human-machine interaction with users (e.g., via touchpads), for example, an intelligent phone, a tablet, etc. The mobile electronic products can run on any operating system, such as android operating system, iOS operating system, etc. Network devices include an electronic device of automatically performing numeral calculations and information processing according to preset or stored instructions. Its hardware includes but is not limited to micro-processors, application specific integrated circuits (ASIC), programmable logic device (PLD), field programmable gate array (FPGA), digital signal processors (DSP), embedded devices, etc. Network devices include but are not limited to: computers, mainframes, single network server, a cloud composed of multiple network server sets or multiple servers. Cloud as used herein is formed by a massive amount of computers or network servers based on cloud computing, and cloud computing is a type of distributed computing, which is a virtual super computer composed of a group of loosely coupled computer sets. Networks include but are not limited to internet, Wide Area Network (WAN), Metropolitan Area Network (MAN), Local Area Network (LAN), Virtual Private Network (VPN), wireless ad-hoc network, etc. In one embodiment, the device may also be programs running on user equipments, network devices, or user equipments and network devices, network devices, touch terminals, or a device composed by integration of network devices and touch terminals through a network.

Other existing devices or those that may appear in the future fall within the protection scope of the application and are incorporated herein by reference, if applicable to the present application.

In the description of the present application, the term “a plurality of” means two or more, unless it is clearly and specifically defined otherwise.

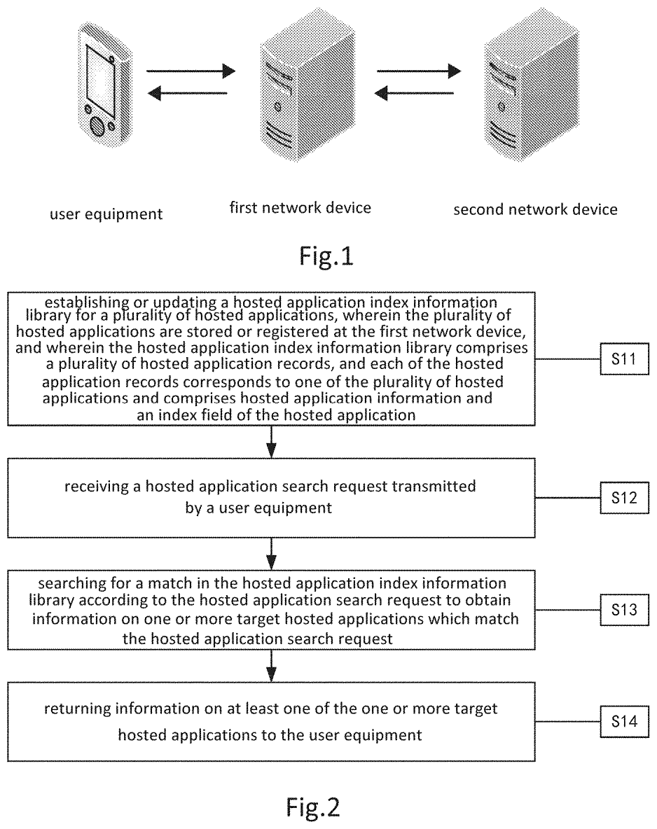

FIG. 1 shows a typical scenario of the present application, in which a first network device establishes communication connections with a user equipment and with a second network device corresponding to a hosted application, respectively. A user may transmit a hosted application search request to the first network device through the user equipment, and obtain corresponding target hosted application information. The user equipment includes but is not limited to a mobile device and a personal computer (PC) device, etc. The first network device includes but is not limited to a host application server which provides services for smart terminals and can carry hosted applications, such as an instant messaging server, etc. The second network device includes but is not limited to an application server corresponding to a hosted application, and the hosted application comprises an application which is logged in with aid of and in conjunction with the first network device and can be used without downloading, such as an applet, etc. In some embodiments of this solution, the first network device may establish or update a hosted application index information library for hosted applications through a communication connection with the second network device at first, search for a match in the hosted application index information library based on the hosted application search request transmitted by the user equipment, and return corresponding target hosted application information. The hosted application index information library comprises information on hosted applications stored or registered at the first network device and index fields corresponding to the hosted applications. In other embodiments of this solution, the first network device may also determine a corresponding hosted application search interface according to the hosted application search request transmitted by the user equipment, and obtain search response information from the corresponding second network device in real time through the hosted application search interface, and then return target hosted application information to the user equipment based on the obtained search response information. The hosted application search interface comprises an interface customized by the first network device for running search in the second network device corresponding to the hosted application.

To further describe solutions of embodiments of the present application, examples will be introduced below in connection with FIG. 2, from the perspective of a method for searching for a hosted application in which various devices interact with each other.

FIG. 2 shows a method for searching for a hosted application at a first network device according to an embodiment of a first aspect of the present application. The method may be applied to the system as shown in FIG. 1 and includes step S11, step S12, step S13 and step S14. In step S11, the first network device establishes or updates a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application. In step S12, the first network device receives a hosted application search request transmitted by a user equipment. In step S13, the first network device searches for a match in the hosted application index information library according to the hosted application search request to obtain information on one or more target hosted applications which match the hosted application search request. In step S14, the first network device returns information on at least one of the one or more target hosted applications to the user equipment.

In one embodiment, in step S11, the first network device establishes or updates a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application. For example, the first network device has stored or registered hosted applications, and establishes or updates a hosted application index information library for the plurality of hosted applications, and the first network device may establish or update mapping relationships between corresponding index fields and corresponding hosted application information based on hosted application records corresponding to a massive number of users, such as search records of hosted applications, etc., and to establish or update the hosted application index information library for the plurality of hosted applications. The first network device may also establish or update corresponding hosted application records and thus establish or update the index information library of the plurality of hosted applications by obtaining mapping relationships between index fields and corresponding hosted application information from the second network device via a preset data access interface or a search interface. The hosted application information includes but is not limited to one or more of identification information on a hosted application such as a name, executable codes etc., page contents of the hosted application such as related page contents within the hosted application corresponding to an index field of the hosted application etc., and link information on page contents of the hosted application such as a page URL, etc. The index fields include but are not limited to description keywords corresponding to hosted application information, etc. In an implementation, establishing or updating the mapping relationships between the corresponding index fields and the corresponding hosted application information may comprise: establishing or updating the mapping relationships between the corresponding index fields and the identification information and/or access data information of the hosted applications. For example, if the access data information comprises the link information of the page contents of the hosted applications such as page URLs, the mapping relationships between the corresponding index fields and URLs of one or more page from one or more hosted applications may be established or updated. A mapping relationship may also be established between an URL of a page from a hosted application with one or more index fields.

In step S12, the first network device receives a hosted application search request transmitted by a user equipment. For example, a user holds a user equipment. The user equipment is equipped with an application corresponding to the first network device. The user equipment establishes a communication connection with the first network device through the application. The user searches for information related to a hosted application within the application. The user equipment generates a corresponding hosted application search request based on information inputted by the user/a selection operation of the user such as selection of historical search records, etc., and transmits the hosted application search request to the first network device, and the hosted application search request includes but is not limited to text information, voice information, etc. In some embodiments, step S11 may be performed before step S12. In one embodiment, step S12 may be performed before step S11.

In step S13, the first network device searches for a match in the hosted application index information library according to the hosted application search request to obtain information on one or more target hosted applications which match the hosted application search request. For example, in response to receiving the hosted application search request, the first network device searches for a match in the hosted application index information database based on the received hosted application search request, and obtains information on one or more target hosted applications which match the hosted application search request. As an example, the first network device obtains keywords contained in the hosted application search request by operations such as word segmentation and keyword extraction on text information contained in the hosted application search request. Further, the first network device searches for a match of index field in the hosted application index information library with one or more of the plurality of keywords. If the index field contains one or more of the plurality of keywords, the information on the hosted application corresponding to the index field is determined as the information on the target hosted application, and thus information on one or more target hosted applications corresponding to the plurality of keywords are obtained.

In step S14, the first network device returns information on at least one of the one or more target hosted applications to the user equipment. For example, the first network device returns information on at least one of one or more target hosted applications to the user equipment after obtaining the information on the one or more target hosted applications corresponding to the hosted application search request. As an example, the first network device ranks of the target hosted applications according to search popularity, and returns information on one or more target hosted applications with top rankings to the user equipment. As another example, the first network device ranks the target hosted applications according to user ratings, and returns information on one or more target hosted applications with top rankings to the user equipment. As yet another example, the first network device picks several target hosted applications out of the one or more target hosted applications randomly, and returns information on these target hosted applications to the user equipment. In an implementation, information returned to the user equipment may comprise one or more of identification information on each of the target hosted applications, page contents of the target hosted application, and link information of the page contents of the target hosted application such as page URLs, etc.

For example, a user holds a user equipment. The user equipment is equipped with an application corresponding to the first network device. The user equipment establishes a communication connection with the first network device through the application. The user equipment generates a corresponding hosted application search request based on the user's operation. As an example, if the user enters text information of “product XX” in a hosted application search bar of the corresponding application on the user equipment, the user equipment generates a hosted application search request containing the text information, and transmits the hosted application search request to the first network device. The first network device has stored or registered hosted applications, and has established a hosted application index information library for the plurality of hosted applications according to search records from users/a predetermined access data interface/a search interface. The hosted application index information library contains many hosted application records, and each of the hosted application records corresponds to one of the plurality of hosted applications, and contains hosted application information and an index field of the hosted application, such as hosted application information of “123 merchant” and an index field of “product XX”, hosted application information of “132 merchant” and an index field of “product XX”, and hosted application information of “123 merchant” and an index field of “product XXX”, etc. The hosted application information of “123 merchant” may be a name of a hosted application of “123 merchant”, executable codes to connect to a related server of “123 merchant” or a page content related to “product XX” provided by “123 merchant”. In one embodiment, the hosted application information of “123 merchant” is taken as an example to illustrate these embodiments, and that other existing hosted application information or those that may appear in the future may also be applicable to the present application.

The first network device receives a hosted application search request for “product XX” transmitted by the user equipment, searches for a match of “product XX” with each of the index fields in the database, and determines the index field of “product XX” and two hosted application records corresponding to it, such as hosted application information of “123 merchant” and an index field of “product XX” and hosted application information of “132 merchant” and an index field of “product XX”. The first network device determines the corresponding hosted application information of “123 merchant” and the corresponding hosted application information of “132 merchant” as information of the target hosted applications, and returns the information on the two target hosted applications to the user equipment, or picks one target hosted application randomly or with preference according to rules and return information on the picked target hosted application to the user equipment. The user equipment receives and presents the target hosted application. If information on two target hosted applications is received, the information on the two target hosted applications may be ranked according to rules, such as search popularity, etc.

In one embodiment, mentioned hosted application information and/or index field is merely an example and that other existing hosted application information and/or index fields or those that may appear in the future fall within the protection scope of the application and are incorporated herein by reference, if applicable to the present application.

In some embodiments, the above mentioned step S11 comprises a sub-step S11a (not shown) and a sub-step S11b (not shown). In step S11a, the first network device obtains access data information from a second network device corresponding to each of the hosted applications through a predetermined data access interface for the plurality of hosted applications stored or registered at the first network device. In step S11b, the first network device establishes or updates the hosted application index information library for the plurality of hosted applications according to the access data information, and the hosted application index information library comprises hosted application records, and each of the hosted application records corresponds to one of the plurality of hosted applications and comprises hosted application information and the index field of the hosted application. For example, the predetermined data access interface comprises an interface with automatic access functions for requesting a website and extracting data, such as a web crawler which automatically grabs website information according to rules, etc. In some implementations of the present application, the data access interface may be provided by a host application to the corresponding hosted application. Corresponding pages of the hosted application may be accessed via the data access interface. Here, the page to be accessed may be preset by the host application. For example, the host application may configure that a home page of the hosted application is to be accessed through the data access interface by default. In addition, the hosted application may flexibly set or select one or more pages to be accessed based on its own needs, and save information related to the pages to be accessed in data access interface settings. Access data information includes but is not limited to page contents related to the hosted application obtained through the data access interface, such as page introduction, contents, or a page URL, etc. The first network device obtains corresponding access data information from a second network device corresponding to each of the hosted applications through a predetermined data access interface. The access data information comprises webpage contents corresponding to the second network device which can be crawled, etc. The first network device then establishes or updates the hosted application index information library according to the crawled webpage contents. For example, the first network device determines index fields corresponding to the webpage contents, and establishes or updates corresponding hosted application records. If the network device has not established a hosted application index information database for now, the first network device establishes a hosted application index information database for hosted applications according to hosted application records. If the first network device has established a hosted application index information database, the first network device updates the hosted application index information database according to the plurality of hosted application records.

For example, according to the plurality of hosted applications stored or registered at the first network device, the first network device obtains the page contents corresponding to each of the hosted applications through a web crawler. For example, the first network device selects a short-listed web pages from the pages corresponding to the second network device, uses link addresses of the web pages as seed Uniform Resource Locators (URLs), and puts these seeds into a URL queue to be crawled. The URL queue to be crawled is read sequentially by a crawler, and the link addresses are converted to IP addresses corresponding to website servers by Domain Name System (DNS) parsing on the URLs. The IP addresses and relative path names of the web pages are then handed to a webpage downloader, which is responsible for the downloading of the pages. On one hand, a web page downloaded to the local is stored into a page library for subsequent processing after indexes are established. For example, keywords from pages are extracted as index fields, and hosted application records with corresponding index fields and hosted application information are established or updated, and in turn a hosted application index information library for hosted applications is established or updated.

In one embodiment, the above mentioned data access interface is merely an example and that other existing data access interfaces or those that may appear in the future fall within the protection scope of the application and are incorporated herein by reference, if applicable to the present application.

In some implementations of the present application, the first network device, i.e., a server of a host application, may set a strategy for crawling data by a web crawler. For example, page contents corresponding to a hosted application is obtained by a web crawler periodically or based on other predetermined trigger conditions.

In some embodiments, in the above mentioned step S11b, when a hosted application corresponding to the access data information has a corresponding hosted application record in the hosted application index information library, the first network device adds description keywords corresponding to the access data information to the index field in the hosted application record. Otherwise, the first network device creates a corresponding hosted application record for the hosted application corresponding to the access data information in the hosted application index information library, and the hosted application record comprises hosted application information and an index field of the hosted application, and the index field comprises the description keywords corresponding to the access data information. For example, the first network device determines corresponding description keywords according to the obtained webpage contents, and if there is a hosted application record corresponding to the webpage contents, the first network device adds the description keywords of the webpage contents to the index field in the hosted application record to update the hosted application record; or if there is no hosted application record corresponding to the webpage contents, the first network device uses the description keywords from the webpage contents as a corresponding index field, to establish and store hosted application record with the index field corresponding to the webpage contents.

For example, the first network device obtains page contents related to “product XX” and “product XXY” provided by “123 merchant” through a web crawler, and determines, by keywords extraction, that description keywords of the page contents related to “product XX” comprise keywords such as “product XX” and “on sale with cash rebate” etc., and that description keywords of the page contents related to “product XXY” comprise keywords such as “product XXY”, etc. If the first network device determines that there is page contents of “product XX” and an index field of “product XX” in the hosted application index information database, the first network device adds the newly added keywords such as “on sale with cash rebate” to the index field of the page contents of “product XX”, to update the hosted application record with the page contents of “product XX” and the index field of “product XX” as a hosted application record with page contents of “product XX” and index fields of “product XX” and “on sale with cash rebate”. In addition, if the first network device determines that there is no hosted application record related to the page contents of “product XXY” in the hosted application index information database, the first network device adds a hosted application record with the page contents of “product XXY” and an index field of “product XXY” to the hosted application index information database.

In one embodiment, the above mentioned hosted application record is merely an example, and that other existing hosted application records or those that may appear in the future fall within the protection scope of the application and are incorporated herein by reference, if applicable to the present application.

In some embodiments, the hosted application information comprises identification information and/or the access data information on the corresponding hosted application. For example, the hosted application information includes but is not limited to a name of a hosted application, executable codes and/or access data information such as page contents related to the hosted application, link information of the page contents of the hosted application such as page URLs, etc.

For example, the hosted application record stored in a database at the first network device comprises corresponding hosted application information and an index field. The hosted application information may comprise a name of the hosted application, executable codes, related page contents, etc., such as a name of “XX merchant” corresponding to “product XX”, the executable codes to establish a communication connection with the second network device corresponding to “XX merchant”, and/or page contents corresponding to “product XX”, etc.

In other embodiments, the above mentioned step S11 comprises a sub-step S11c (not shown) and a sub-step S11d (not shown). In step S11c, for the plurality of hosted applications stored or registered at the first network device, the first network device transmits one or more pieces of search request information to a second network device corresponding to each of the hosted applications through a predetermined search interface, and receives search response information returned by the second network device. In step S11d, the first network device establishes or updates the hosted application index information library for the plurality of hosted applications according to the search response information, and the hosted application index information library comprises the plurality of hosted application records, and each of the hosted application records corresponds to one of the plurality of hosted applications and comprises hosted application information and an index field of the hosted application. For example, the predetermined search interface is used to establish a communication connection between the first network device and the second network device corresponding to each of the hosted applications, transmit the search request information to the second network device, and execute search functions in the second network device to obtain one or more pieces of search response information from the second network device corresponding to each of the hosted applications. The search response information includes but is not limited to page contents related to the hosted application located through keywords in the search request information, such as page introduction, page contents, or a page URL, etc. The first network device establishes or updates hosted application records for hosted applications according to keywords contained in the search request information and correspondingly received one or more pieces of search response information. If the network device has not established a hosted application index information database for now, the first network device establishes a hosted application index information database for hosted applications according to the plurality of hosted application records. If the first network device has established a hosted application index information database, the first network device updates the hosted application index information database according to the plurality of hosted application records.

For example, the first network device transmits one or more pieces of search request information to each of the hosted applications through the predetermined search interface according to the plurality of hosted applications stored or registered at the first network device. Each of the pieces of search request information comprises relatively common search keywords corresponding to the hosted application. The search keywords may be obtained based on big data statistics or preset by the first network device. The first network device then receives one or more pieces of search response information returned by the second network device. For example, the first network device transmits search request information with “product XX” to the second network device corresponding to “123 merchant”, and obtains homepage information on “product XX”, rating page information on “product XX”, etc. returned by the second network device. The first network device establishes or updates hosted application records for hosted applications according to keywords contained in the search request information and correspondingly received one or more pieces of search response information. For example, the first network device establishes or updates a hosted application record of “123 merchant” with an index field of “product XX” and homepage information on “product XX” according to search response information with a keyword of “product XX” and homepage information on “product XX”, and establishes or updates a hosted application record of “123 merchant” with an index field of “product XX” and rating page information on “product XX” according to search response information with a keyword of “product XX” and rating page information on “product XX”, and then establishes or updates a hosted application index information library for the plurality of hosted applications based on these hosted application records.

In one embodiment, the above mentioned search request information and/or search response information is merely an example, and that other existing search request information and/or search response information or those that may appear in the future fall within the protection scope of the application and are incorporated herein by reference, if applicable to the present application.

In some embodiments, in the above mentioned step S11d, when a hosted application corresponding to the search response information has a corresponding hosted application record in the hosted application index information library, the first network device adds search keywords corresponding to the search request information and/or description keywords corresponding to the search response information to the index field in the hosted application record; otherwise, the first network device creates a corresponding hosted application record for the hosted application corresponding to the access data information in the hosted application index information library, and the hosted application record comprises hosted application information and an index field of the hosted application, and the index field comprises the search keywords corresponding to the search request information and/or the description keywords corresponding to the search response information. For example, the first network device establishes a corresponding mapping relationship according search response information contents and search keywords contained in the search request information. If there is a hosted application record corresponding to webpage contents in the search response information, the first network device adds the search keywords of the webpage contents to the index field in the hosted application record to update the hosted application record. Or if there is no hosted application record corresponding to the webpage contents, the first network device uses the search keywords of the webpage contents as a corresponding index field, to establish and store a hosted application record with the index field corresponding to the webpage contents.

For example, the first network device obtains homepage contents and rating page contents, etc. related to “product XX” provided by “123 merchant” through search keywords “product XX”. If the first network device determines that there is homepage contents related to “product XX” and an index field of “123 merchant” in the hosted application index information database, the first network device adds the newly added keywords such as “product XX” to the index field of the homepage contents related to “product XX”, and updates the hosted application record with the page contents of “product XX” and the index field of “product XX” with hosted application information with page contents of “product XX” and an index field of “123 merchant” and “product XX”. In addition, if the first network device determines that there is no hosted application record related to rating page contents of “product XX” in the hosted application index information database, the first network device adds a hosted application record with the rating page contents of “product XX” and the index field of “product XX” to the hosted application index information database.

In some embodiments, the hosted application information comprises identification information and/or the search response information on the corresponding hosted application. For example, the hosted application information includes but is not limited to a name of a hosted application, executable codes and/or search response information such as page contents related to the hosted application, link information of the page contents of the hosted application such as a page URL, etc.

For example, the hosted application record stored in the database at the first network device comprises corresponding hosted application information and an index field. The hosted application information may comprise a name of the hosted application, executable codes and/or related page contents, etc., such as a name of “XX merchant” corresponding to “product XX”, the executable codes to establish a communication connection with the second network device corresponding to “XX merchant”, and/or page contents corresponding to “product XX”, etc.

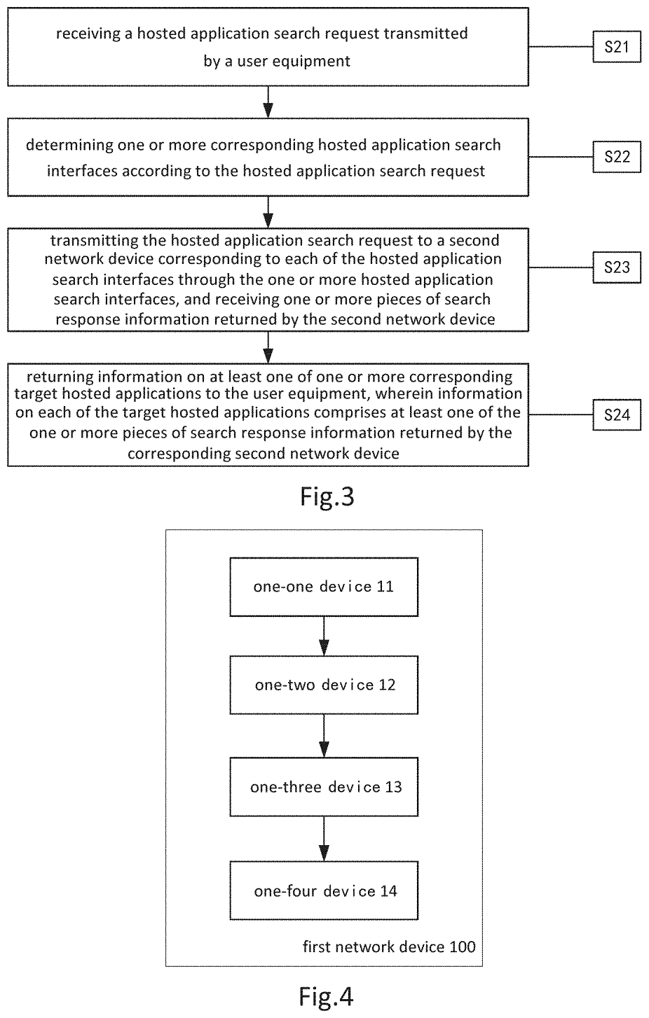

The method for searching for a hosted application provided in a first aspect of the present application is mainly described above in connection with FIG. 2. A method for searching for a hosted application is also provided in a second aspect of the present application, which will be introduced below in connection with FIG. 3.

FIG. 3 shows a method for searching for a hosted application at a first network device according to an embodiment of a second aspect of the present application. The method may be applied to the system as shown in FIG. 1 and includes step S21, step S22, step S23 and step S24. In step S21, the first network device receives a hosted application search request transmitted by a user equipment. In step S22, the first network device determines one or more corresponding hosted application search interfaces according to the hosted application search request. In step S23, the first network device transmits the hosted application search request to a second network device corresponding to each of the hosted application search interfaces through the one or more hosted application search interfaces, and receives one or more pieces of search response information returned by the second network device. In step S24, the first network device returns information of at least one of one or more corresponding target hosted applications to the user equipment, and information on each of the target hosted applications comprises at least one of the one or more pieces of search response information returned by the corresponding second network device.

In one embodiment, in step S21, the first network device receives a hosted application search request transmitted by a user equipment. For example, a user holds a user equipment. The user equipment is equipped with an application corresponding to the first network device. The user equipment establishes a communication connection with the first network device through the application. The user searches for information related to a hosted application within the application. The user equipment generates a corresponding hosted application search request based on information inputted by the user/a selection operation of the user such as selection on historical search records, etc., and transmits the hosted application search request to the first network device, and the hosted application search request includes but is not limited to text information, voice information, etc.

In step S22, the first network device determines one or more corresponding hosted application search interfaces according to the hosted application search request. For example, the hosted application search interface is used to establish a communication connection between the first network device and the second network device. The first network device stores a mapping relationship between hosted application search interfaces and index fields, and compares keywords in the search request information with the index field. If the keywords are identical with the index field, the hosted application search interface corresponding to the index field is determined as a hosted application search interface corresponds to the search request information. The index field comprises keywords or preset keywords corresponding to the hosted application which are obtained by the first network device according to big data.

In step S23, the first network device transmits the hosted application search request to a second network device corresponding to each of the hosted application search interfaces through the one or more hosted application search interfaces, and receives one or more pieces of search response information returned by the second network device. For example, the first network device transmits the search request information to the second network device, and executes search functions in the second network device to obtain one or more pieces of search response information from the second network device corresponding to each of the hosted applications. The search response information includes but is not limited to page contents related to the hosted application located through keywords in the search request information, such as page introduction, page contents, or a page URL, etc.

In step S24, the second network device returns information on at least one of one or more corresponding target hosted applications to the user equipment, and information on each of the target hosted applications comprises at least one of the one or more pieces of search response information returned by the corresponding second network device. For example, the first network device may return all the search response information to the user equipment according to one or more pieces of search response information located and returned by one or more second network devices, or return information on one or more target hosted applications to the user equipment by selecting with preference from the hosted applications according to rules such as search popularity, high rating ranking, etc. In addition, the first network device may select at least one from one or more pieces of search response information with preference as information on one of the one or more target hosted applications to be transmitted to the user equipment when determining information on target hosted applications.

For example, a user holds a user equipment. The user equipment is equipped with an application corresponding to the first network device. The user equipment establishes a communication connection with the first network device through the application. The user equipment generates a corresponding hosted application search request based on the user's operation. As an example, if the user enters text information of “product XX” in a hosted application search bar of the corresponding application on the user equipment, the user equipment generates a hosted application search request containing the text information, and transmits the hosted application search request to the first network device. The first network device has stored or registered hosted applications, and has stored mapping relationships between the hosted application search interfaces and index fields, such as correspondence between a hosted application search interface of “123 merchant” and an index field of “product XX”, correspondence between a hosted application search interface of “132 merchant” and an index field of “product XX”.

The first network device receives a hosted application search request for “product XX” transmitted by the user equipment, searches for a match of “product XX” with each of the index fields in the database, and determines the index field of “product XX” and two hosted application search interfaces corresponding to it, such as a hosted application search interface of “123 merchant” and a hosted application search interface of “132 merchant”. The first network device transmits the search request information containing “product XX” to second network device 1 corresponding to “123 merchant” and second network device 2 corresponding to “132 merchant” respectively. The second network device 1 and the second network device 2 search for “product XX” respectively and obtain corresponding search response information, such as two pieces of search response information including homepage 1 and rating page 1 of “product XX” in the second network device 1, and two pieces of search response information including homepage 2 and rating page 2 of “product XX” in the second network device 2. The first network device receives the two pieces of search response information including the homepage 1 and the rating page 1 of “product XX” returned by the second network device 1, and the two pieces of search response information including the homepage 2 and the rating page 2 of “product XX” returned by the second network device 2.

The first network device then uses the two pieces of search response information including the homepage 1 and the rating page 1 of “product XX” returned by the second network device 1 as target hosted application information 1 corresponding to target hosted application 1 which corresponds to the search response information, or selects one of the two pieces of search response information randomly/with preference as the target hosted application information 1 corresponding to the target hosted application 1 which corresponds to the search response information. Similarly, the first network device uses the two pieces of search response information including the homepage 2 and the rating page 2 of “product XX” returned by the second network device 2 as target hosted application information 2 corresponding to target hosted application 2 which corresponds to the search response information, or selects one of the two pieces of search response information randomly/with preference as the target hosted application information 2 corresponding to the target hosted application 2 which corresponds to the search response information. The first network device returns the target hosted application information 1 and the target hosted application information 2 to the user equipment, or select one of them randomly/with preference and returns the selected one to the user equipment. The user equipment receives and presents the target hosted application. If information on two target hosted applications is received, the information on two target hosted applications may be ranked according to rules, such as search popularity, etc.

In one embodiment, the above mentioned search request information and/or hosted application search interface is merely an example, and that other existing search request information and/or hosted application search interface or those that may appear in the future fall within the protection scope of the application and are incorporated herein by reference, if applicable to the present application.

In some embodiments, the target hosted application information further comprises identification information on a corresponding hosted application. For example, the hosted application information also includes but is not limited to identification information on the hosted application, such as a name, executable codes and the like of the hosted application.

For example, the first network device receives the two pieces of search response information including the homepage 1 and the rating page 1 of “product XX” returned by the second network device 1, and returns the two pieces of search response information and identification information on the hosted application 1 corresponding to the second network device 1, such as a name, executable codes and the like of the hosted application 1 to the user equipment as the target hosted application information 1.

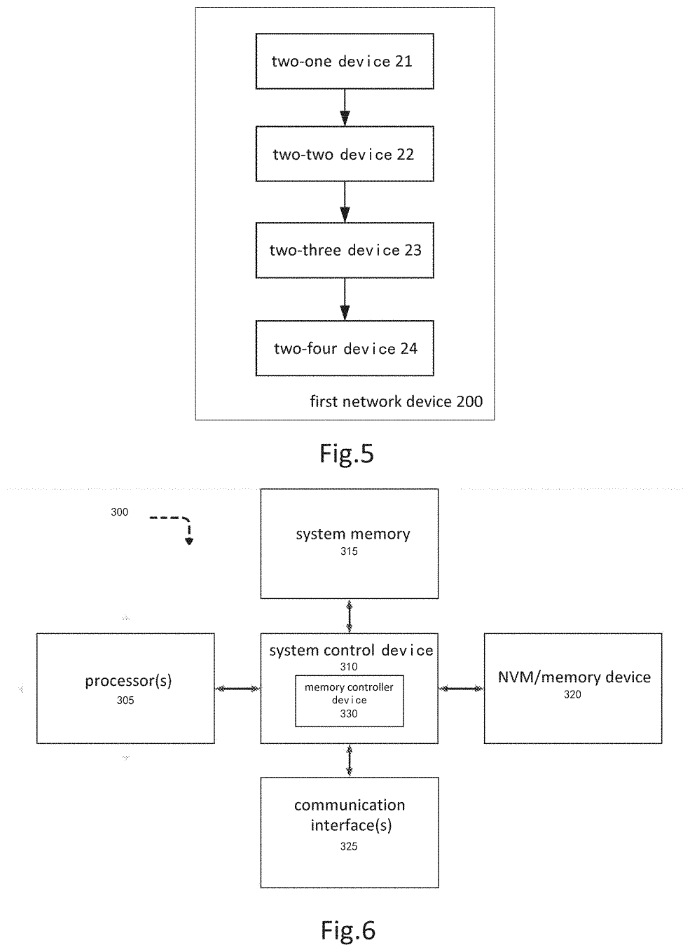

The methods provided in the embodiments of the present application are introduced above from the perspective of various devices' interactions. Accordingly, the present application also provides corresponding devices for implementing the above mentioned methods, which will be described below in connection with FIGS. 4 and 5.

FIG. 4 shows a first network device 100 for searching for a hosted application according to an embodiment of a third aspect of the present application. The first network device 100 may be applied to the system shown in FIG. 1, and includes one-one device 11, one-two device 12, one-three device 13 and one-four device 14. The one-one device 11 is used to establish or update a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application. The one-two device 12 is used to receive a hosted application search request transmitted by a user equipment. The one-three device 13 is used to search for a match in the hosted application index information library according to the hosted application search request to obtain information on one or more target hosted applications which match the hosted application search request. The one-four device 14 is used to return information on at least one of the one or more target hosted applications to the user equipment.

In one embodiment, the one-one device 11 is used to establish or update a hosted application index information library for hosted applications, and the plurality of hosted applications are stored or registered at the first network device, and the hosted application index information library comprises hosted application records, and each of the hosted application records corresponds to one of the plurality of hosted applications and comprises hosted application information and an index field of the hosted application. For example, the first network device has stored or registered hosted applications, and establishes or updates a hosted application index information library for the plurality of hosted applications, and the first network device may establish or update mapping relationships between corresponding index fields and corresponding hosted application information based on hosted application records corresponding to a massive number of users, such as search records of hosted applications, etc., and to establish or update the hosted application index information library for the plurality of hosted applications. The first network device may also establish or update corresponding hosted application records and thus establish or update the index information library of the plurality of hosted applications by obtaining mapping relationships between index fields and corresponding hosted application information from the second network device via a preset data access interface or a search interface. The hosted application information includes but is not limited to one or more of identification information on hosted applications such as names, executable codes etc., page contents of hosted applications such as related page contents within the hosted application corresponding to an index field of the hosted application etc., and link information on the page contents of the hosted application such as a page URL, etc. The index fields include but are not limited to description keywords corresponding to hosted application information, etc. In an implementation, establishing or updating the mapping relationships between the corresponding index fields and the corresponding hosted application information may comprise: establishing or updating the mapping relationships between the corresponding index fields and the identification information and/or access data information of the hosted applications. For example, if the access data information comprises the link information of the page contents of the hosted applications such as page URLs, the mapping relationships between the corresponding index fields and URLs of one or more pages from one or more hosted applications may be established or updated. A mapping relationship may also be established between an URL of a page from a hosted application with one or more index fields.

The one-two device 12 is used to receive a hosted application search request transmitted by a user equipment. For example, a user holds a user equipment. The user equipment is equipped with an application corresponding to the first network device. The user equipment establishes a communication connection with the first network device through the application. The user searches for information related to a hosted application within the application. The user equipment generates a corresponding hosted application search request based on information inputted by the user/a selection operation of the user such as selection of historical search records, etc., and transmits the hosted application search request to the first network device, and the hosted application search request includes but is not limited to text information, voice information, etc. In some embodiments, step S11 may be performed before step S12. In one embodiment, step S12 may be performed before step S11.

The one-three device 13 is used to search for a match in the hosted application index information library according to the hosted application search request to obtain information on one or more target hosted applications which match the hosted application search request. For example, in response to receiving the hosted application search request, the first network device searches for a match in the hosted application index information database based on the received hosted application search request, and obtains information on one or more target hosted applications which match the hosted application search request. For example, the first network device obtains keywords contained in the hosted application search request by operations such as word segmentation and keyword extraction on text information contained in the hosted application search request. Further, the first network device searches for a match of index field in the hosted application index information library with one or more of the plurality of keywords. If the index field contains one or more of the plurality of keywords, the information on the hosted application corresponding to the index field is determined as the information on the target hosted application, and thus information on one or more target hosted applications corresponding to the plurality of keywords are obtained.

The one-four device 14 is used to return information on at least one of the one or more target hosted applications to the user equipment. For example, the first network device returns information on at least one of one or more target hosted applications to the user equipment after obtaining the information on the one or more target hosted applications corresponding to the hosted application search request. As an example, the first network device ranks the target hosted applications according to search popularity, and returns information on one or more target hosted applications with top rankings to the user equipment. As another example, the first network device ranks the target hosted applications according to user ratings, and returns information on one or more target hosted applications with top rankings to the user equipment. As yet another example, the first network device picks several target hosted applications out of the one or more target hosted applications randomly, and returns information on these target hosted applications to the user equipment In an implementation, information returned to the user equipment may comprise one or more of identification information on each of target hosted applications, page contents of the target hosted application, and link information of the page contents of the target hosted application such as a page URL, etc.

For example, a user holds a user equipment. The user equipment is equipped with an application corresponding to the first network device. The user equipment establishes a communication connection with the first network device through the application. The user equipment generates a corresponding hosted application search request based on the user's operation. As an example, if the user enters text information of “product XX” in a hosted application search bar of the corresponding application on the user equipment, the user equipment generates a hosted application search request containing the text information, and transmits the hosted application search request to the first network device. The first network device has stored or registered hosted applications, and has established a hosted application index information library for the plurality of hosted applications according to search records from uses/a predetermined access data interface/a search interface. The hosted application index information library contains many hosted application records, and each of the hosted application records corresponds to one of the plurality of hosted applications, and contains hosted application information and an index field of the hosted application, such as hosted application information of “123 merchant” and an index field of “product XX”, hosted application information of “132 merchant” and an index field of “product XX”, and hosted application information of “123 merchant” and an index field of “product XXX”, etc. The hosted application information of “123 merchant” may be a name of a hosted application of “123 merchant”, executable codes to connect to a related server of “123 merchant” or a page content related to “product XX” provided by “123 merchant”. In one embodiment, the hosted application information of “123 Merchant” is taken as an example to illustrate these embodiments, and that other existing hosted application information or those that may appear in the future may also be applicable to the present application.

The first network device receives a hosted application search request for “product XX” transmitted by the user equipment, searches for a match of “product XX” with each of the index fields in the database, and determines the index field of “product XX” and two hosted application records corresponding to it, such as hosted application information of “123 merchant” and an index field of “product XX” and hosted application information of “132 merchant” and an index field of “product XX”. The first network device determines the corresponding hosted application information of “123 merchant” and the corresponding hosted application information of “132 merchant” as information of the target hosted applications, and returns the information on the two target hosted applications to the user equipment, or picks one target hosted application randomly or with preference according to rules and return information on the picked target hosted application to the user equipment. The user equipment receives and presents the target hosted application. If information on two target hosted applications are received, the information on the two target hosted applications may be ranked according to rules, such as search popularity, etc.

In one embodiment, the above mentioned hosted application information and/or index field is merely an example, and that other existing hosted application information and/or index fields or those that may appear in the future fall within the protection scope of the application and are incorporated herein by reference, if applicable to the present application.

In some embodiments, the above mentioned one-one device 11 comprises one-one-one device 11a (not shown) and one-one-two device 11b (not shown). The one-one-one device 11a is used to obtain access data information from a second network device corresponding to each of the hosted applications through a predetermined data access interface for the plurality of hosted applications stored or registered at the first network device. The one-one-two device 11a is used to establish or update the hosted application index information library for the plurality of hosted applications according to the access data information, and the hosted application index information library comprises hosted application records, and each of the hosted application records corresponds to one of the plurality of hosted applications and comprises hosted application information and the index field of the hosted application. For example, the predetermined data access interface comprises an interface with automatic access functions for requesting a website and extracting data, such as a web crawler which automatically grabs website information according to rules, etc. In some implementations of the present application, the data access interface may be provided by a host application to the corresponding hosted application. Corresponding pages of the hosted application may be accessed via the data access interface. Here, the page to be accessed may be preset by the host application. For example, the host application may configure that a home page of the hosted application is to be accessed through the data access interface by default. In addition, the hosted application may flexibly set or select one or more pages to be accessed based on its own needs, and save information related to the pages to be accessed in data access interface settings. Access data information includes but is not limited to page contents related to the hosted application obtained through the data access interface, such as page introduction, contents, or a page URL, etc. The first network device obtains corresponding access data information from a second network device corresponding to each of the hosted applications through a predetermined data access interface. The access data information comprises webpage contents corresponding to the second network device which can be crawled, etc. The first network device then establishes or updates the hosted application index information library according to the crawled webpage content. For example, the first network device determines index fields corresponding to the webpage contents, and establishes or updates corresponding hosted application records. If the network device has not established a hosted application index information database for now, the first network device establishes a hosted application index information database for hosted applications according to hosted application records. If the first network device has established a hosted application index information database, the first network device updates the hosted application index information database according to hosted application records.

For example, according to the plurality of hosted applications stored or registered at the first network device, the first network device obtains the page content corresponding to each of the hosted applications through a web crawler. For example, the first network device selects a short-listed web pages from the pages corresponding to the second network device, uses link addresses of the web pages as seed Uniform Resource Locators (URLs), and puts these seeds into a URL queue to be crawled. The URL queue to be crawled is read sequentially by a crawler, and the link addresses are converted to IP addresses corresponding to website servers by Domain Name System (DNS) parsing on the URLs. The IP addresses and relative path names of the web pages are then handed to a webpage downloader, which is responsible for the downloading of the pages. On one hand, a web page downloaded to the local is stored into a page library for subsequent processing after indexes are established. For example, keywords are extracted from pages as index fields, and hosted application records with corresponding index fields and hosted application information are established or updated, and in turn a hosted application index information library for hosted applications is established or updated.

In one embodiment, the above mentioned data access interface is merely an example, and that other existing data access interfaces or those that may appear in the future fall within the protection scope of the application and are incorporated herein by reference, if applicable to the present application.

In some implementations of the present application, the first network device, i.e., a server of a host application, may set a strategy for crawling data by a web crawler. For example, page contents corresponding to a hosted application is obtained by a web crawler periodically or based on other predetermined trigger conditions.

In some embodiments, when a hosted application corresponding to the access data information has a corresponding hosted application record in the hosted application index information library, the above mentioned one-one-two-device is used to add description keywords corresponding to the access data information to the index field in the hosted application record; otherwise, the first network device creates a corresponding hosted application record for the hosted application corresponding to the access data information in the hosted application index information library, and the hosted application record comprises hosted application information and an index field of the hosted application, and the index field comprises the description keywords corresponding to the access data information. For example, the first network device determines corresponding description keywords according to the obtained webpage contents, and if there is a hosted application record corresponding to the webpage contents, the first network device adds the description keywords of the webpage contents to the index field in the hosted application record to update the hosted application record; or if there is no hosted application record corresponding to the webpage contents, the first network device uses the description keywords from the webpage contents as a corresponding index field, to establish and store hosted application record with the index field corresponding to the webpage contents.

For example, the first network device obtains page contents related to “product XX” and “product XXY” provided by “123 merchant” through a web crawler, and determines, by keywords extraction, that description keywords of the page contents related to “product XX” comprise keywords such as “product XX” and “on sale with cash rebate” etc., and that description keywords of the page contents related to “product XXY” comprise keywords such as “product XXY”, etc. If the first network device determines that there is page contents of “product XX” and an index field of “product XX” in the hosted application index information database, the first network device adds the newly added keywords such as “on sale with cash rebate” to the index field of the page contents of “product XX”, to update the hosted application record with the page contents of “product XX” and the index field of “product XX” as a hosted application record with page contents of “product XX” and index fields of “product XX” and “on sale with cash rebate”. In addition, if the first network device determines that there is no hosted application record related to the page contents of “product XXY” in the hosted application index information database, the first network device adds a hosted application record with the page contents of “product XXY” and an index field of “product XXY” to the hosted application index information database.

In one embodiment, the above mentioned hosted application record is merely an example, and that other existing hosted application records or those that may appear in the future fall within the protection scope of the application and are incorporated herein by reference, if applicable to the present application.

In some embodiments, the hosted application information comprises identification information and/or the access data information on the corresponding hosted application. For example, the hosted application information includes but is not limited to a name of a hosted application, executable codes and/or access data information such as page contents related to the hosted application, link information of the page contents of the hosted application such as a page URL, etc.

For example, the hosted application record stored in a database at the first network device comprises corresponding hosted application information and an index field. The hosted application information may comprise a name of the hosted application, executable codes, related page contents, etc., such as a name of “XX merchant” corresponding to “product XX”, the executable codes to establish a communication connection with the second network device corresponding to “XX merchant”, and/or page contents corresponding to “product XX”, etc.

In other embodiments, the above mentioned one-one device 11 comprises one-one-three device 11c (not shown) and one-one-four device 11d (not shown). For the plurality of hosted applications stored or registered at the first network device, the one-one-three device 11c is used to transmit one or more pieces of search request information to a second network device corresponding to each of the hosted applications through a predetermined search interface, and receive search response information returned by the second network device. The one-one-four device 11d is used to establish or update the hosted application index information library for the plurality of hosted applications according to the search response information, and the hosted application index information library comprises the plurality of hosted application records, and each of the hosted application records corresponds to one of the plurality of hosted applications and comprises hosted application information and an index field of the hosted application. For example, the predetermined search interface is used to establish a communication connection between the first network device and the second network device corresponding to each of the hosted applications, transmit the search request information to the second network device, and execute search functions in the second network device to obtain one or more pieces of search response information from the second network device corresponding to each of the hosted applications. The search response information includes but is not limited to page contents related to the hosted application located through keywords in the search request information, such as page introduction, page contents, or a page URL, etc. The first network device establishes or updates hosted application records for hosted applications according to keywords contained in the search request information and correspondingly received one or more pieces of search response information. If the network device has not established a hosted application index information database for now, the first network device establishes a hosted application index information database for hosted applications according to the plurality of hosted application records. If the first network device has established a hosted application index information database, the first network device updates the hosted application index information database according to the plurality of hosted application records.

For example, the first network device transmits one or more pieces of search request information to each of the hosted applications through the predetermined search interface according to the plurality of hosted applications stored or registered at the first network device. Each of the pieces of search request information comprises relatively common search keywords corresponding to the hosted application. The search keywords may be obtained based on big data statistics or preset by the first network device. The first network device then receives one or more pieces of search response information returned by the second network device. For example, the first network device transmits search request information with “product XX” to the second network device corresponding to “123 merchant”, and obtains homepage information on “product XX”, rating page information on “product XX”, etc. returned by the second network device. The first network device establishes or updates hosted application records for hosted applications according to keywords contained in the search request information and correspondingly received one or more pieces of search response information. For example, the first network device establishes or updates a hosted application record of “123 merchant” with an index field of “product XX” and homepage information on “product XX” according to search response information with a keyword of “product XX” and homepage information on “product XX”, and establishes or updates a hosted application record of “123 merchant” with an index field of “product XX” and rating page information on “product XX” according to search response information with a keyword of “product XX” and rating page information on “product XX”, and then establishes or updates a hosted application index information library for the plurality of hosted applications based on these hosted application records.

In one embodiment, the above mentioned search request information and/or search response information is merely an example, and that other existing search request information and/or search response information or those that may appear in the future fall within the protection scope of the application and are incorporated herein by reference, if applicable to the present application.

In some embodiments, when a hosted application corresponding to the search response information has a corresponding hosted application record in the hosted application index information library, the above mentioned one-one-four device 11d is used to add search keywords corresponding to the search request information and/or description keywords corresponding to the search response information to the index field in the hosted application record; otherwise, the first network device creates a corresponding hosted application record for the hosted application corresponding to the access data information in the hosted application index information library, and the hosted application record comprises hosted application information and an index field of the hosted application, and the index field comprises the search keywords corresponding to the search request information and/or the description keywords corresponding to the search response information. For example, the first network device establishes a corresponding mapping relationship according to search response information contents and search keywords contained in the search request information. If there is a hosted application record corresponding to webpage contents in the search response information, the first network device adds the search keywords of the webpage contents to the index field in the hosted application record to update the hosted application record. Or if there is no hosted application record corresponding to the webpage contents, the first network device uses the search keywords of the webpage contents as a corresponding index field, to establish and store a hosted application record with the index field corresponding to the webpage contents.

For example, the first network device obtains homepage contents and rating page contents, etc. related to “product XX” provided by “123 merchant” through search keywords of “product XX”. If the first network device determines that there is homepage contents related to “product XX” and an index field of “123 merchant” in the hosted application index information database, the first network device adds the newly added keywords such as “product XX” to the index field of the homepage contents related to “product XX”, and updates the hosted application record with the page contents of “product XX” and the index field of “product XX” with hosted application information with page contents of “product XX” and an index field of “123 merchant” and “product XX”. In addition, if the first network device determines that there is no hosted application record related to rating page contents of “product XX” in the hosted application index information database, the first network device adds a hosted application record with the rating page contents of “product XX” and the index field of “product XX” to the hosted application index information database.

In some embodiments, the hosted application information comprises identification information and/or the search response information on the corresponding hosted application. For example, the hosted application information includes but is not limited to a name of a hosted application, executable codes and/or search response information such as page contents related to the hosted application, link information of the page contents of the hosted application such as a page URL, etc.

For example, the hosted application record stored in the database at the first network device comprises corresponding hosted application information and an index field. The hosted application information may comprise a name of the hosted application, executable codes and/or related page contents, etc., such as a name of “XX merchant” corresponding to “product XX”, the executable codes to establish a communication connection with the second network device corresponding to “XX merchant”, and/or page content corresponding to “product XX”, etc.

The first network device 100 for searching for a hosted application provided in a third aspect of the present application is mainly described above in connection with FIG. 4. The first network device 200 for searching for a hosted application is also provided in a fourth aspect of the present application, which will be introduced below in connection with FIG. 5.

FIG. 5 shows a first network device 200 for searching for a hosted application according to an embodiment of a fourth aspect of the present application. The first network device 200 may be applied to the system shown in FIG. 1, and includes two-one device 21, two-two device 22, two-three device 23 and two-four device 24. The two-one device 21 is used to receive a hosted application search request transmitted by a user equipment. The two-two device 22 is used to determine one or more corresponding hosted application search interfaces according to the hosted application search request. The two-three device 23 is used to transmit the hosted application search request to a second network device corresponding to each of the hosted application search interfaces through the one or more hosted application search interfaces, and receive one or more pieces of search response information returned by the second network device. The two-four device 24 is used to return information on at least one of one or more corresponding target hosted applications to the user equipment, and information on each of the target hosted applications comprises at least one of the one or more pieces of search response information returned by the corresponding second network device.

In one embodiment, the two-one device 21 is used to receive a hosted application search request transmitted by a user equipment. For example, a user holds a user equipment. The user equipment is equipped with an application corresponding to the first network device. The user equipment establishes a communication connection with the first network device through the application. The user searches for information related to a hosted application within the application. The user equipment generates a corresponding hosted application search request based on information inputted by the user/a selection operation of the user such as selection on historical search records, etc., and transmits the hosted application search request to the first network device, and the hosted application search request includes but is not limited to text information, voice information, etc.

The two-two device 22 is used to determine one or more corresponding hosted application search interfaces according to the hosted application search request. For example, the hosted application search interface is used to establish a communication connection between the first network device and the second network device. The first network device stores a mapping relationship between hosted application search interfaces and index fields, and compares keywords in the search request information with the index field. If the keywords are identical with the index field, the hosted application search interface corresponding to the index field is determined as a hosted application search interface corresponds to the search request information. The index field comprises keywords or preset keywords corresponding to the hosted application which are obtained by the first network device according to big data.

The two-three device 23 is used to transmit the hosted application search request to a second network device corresponding to each of the hosted application search interfaces through the one or more hosted application search interfaces, and receive one or more pieces of search response information returned by the second network device. For example, the first network device transmits the search request information to the second network device, and executes search functions in the second network device to obtain one or more pieces of search response information from the second network device corresponding to each of the hosted applications. The search response information includes but is not limited to page contents related to the hosted application located through keywords in the search request information such as page introduction, page contents, or a page URL, etc.

The two-four device 24 is used to return information on at least one of one or more corresponding target hosted applications to the user equipment, and information on each of the target hosted applications comprises at least one of the one or more pieces of search response information returned by the corresponding second network device. For example, the first network device may return all the search response information to the user equipment according to one or more pieces of search response information located and returned by one or more second network devices, or return information on one or more target hosted applications to the user equipment by selecting with preference from the hosted applications according to rules such as search popularity, high rating ranking, etc. In addition, the first network device may select at least one from one or more pieces of search response information with preference as information on one of the one or more target hosted applications to be transmitted to the user equipment when determining information on target hosted applications.

For example, a user holds a user equipment. The user equipment is equipped with an application corresponding to the first network device. The user equipment establishes a communication connection with the first network device through the application. The user equipment generates a corresponding hosted application search request based on the user's operation. As an example, if the user enters text information of “product XX” in a hosted application search bar of the corresponding application on the user equipment, the user equipment generates a hosted application search request containing the text information, and transmits the hosted application search request to the first network device. The first network device has stored or registered hosted applications, and has stored mapping relationships between the hosted application search interfaces and index fields, such as correspondence between a hosted application search interface of “123 merchant” and an index field of “product XX”, correspondence between a hosted application search interface of “132 merchant” and an index field of “product XX”.

The first network device receives a hosted application search request for “product XX” transmitted by the user equipment, search for a match of “product XX” with each of the index fields in the database, and determines the index field of “product XX” and two hosted application search interfaces corresponding to it, such as a hosted application search interface of “123 merchant” and a hosted application search interface of “132 merchant”. The first network device transmits the search request information containing “product XX” to second network device 1 corresponding to “123 merchant” and second network device 2 corresponding to “132 merchant” respectively. The second network device 1 and the second network device 2 search for “product XX” respectively and obtain corresponding search response information, such as two pieces of search response information including homepage 1 and rating page 1 of “product XX” in the second network device 1, and two pieces of search response information including homepage 2 and rating page 2 of “product XX” in the second network device 2. The first network device receives the two pieces of search response information including the homepage 1 and the rating page 1 of “product XX” returned by the second network device 1, and the two pieces of search response information including the homepage 2 and the rating page 2 of “product XX” returned by the second network device 2.

The first network device then uses the two pieces of search response information including the homepage 1 and the rating page 1 of “product XX” returned by the second network device las target hosted application information 1 corresponding to target hosted application 1 which corresponds to the search response information, or selects one of the two pieces of search response information randomly/with preference as the target hosted application information 1 corresponding to the target hosted application 1 which corresponds to the search response information. Similarly, the first network device uses the two pieces of search response information including the homepage 2 and the rating page 2 of “product XX” returned by the second network device 2 as target hosted application information 2 corresponding to target hosted application 2 which corresponds to the search response information, or selects one of the two pieces of search response information randomly/with preference as the target hosted application information 2 corresponding to the target hosted application 2 which corresponds to the search response information. The first network device returns the target hosted application information 1 and the target hosted application information 2 to the user equipment, or select one of them randomly/with preference and returns the selected one to the user equipment. The user equipment receives and presents the target hosted application. If information on two target hosted applications is received, the information on two target hosted applications may be ranked according to rules, such as search popularity, etc.

In one embodiment, the above mentioned search request information and/or hosted application search interface is merely an example, and that other existing search request information and/or hosted application search interface or those that may appear in the future fall within the protection scope of the application and are incorporated herein by reference, if applicable to the present application.

In some embodiments, the target hosted application information further comprises identification information on a corresponding hosted application. For example, the hosted application information also includes but is not limited to identification information on the hosted application, such as a name, executable codes and the like of the hosted application.

For example, the first network device receives the two pieces of search response information including the homepage 1 and the rating page 1 of “product XX” returned by the second network device 1, and returns the two pieces of search response information and identification information on the hosted application 1 corresponding to the second network device 1, such as a name, executable codes and the like of the hosted application 1 to the user equipment as the target hosted application information 1.

The present application also provides a computer readable storage medium storing computer codes thereon, and the computer codes when executed, cause the method as recited in any one of the above-mentioned clauses to be performed.

The present application also provides a computer program product, and the computer program product when executed by a computer device, cause the method as recited in any one of the above-mentioned clauses to be performed.

The present application also provides a computer device. The computer device comprises:

one or more processors; and

a memory for storing one or more computer programs;

and the one or more computer programs, when executed by the one or more processors, cause the one or more processors to implement the method as recited in any one of above-mentioned clauses.

FIG. 6 shows an exemplary system which may be used to implement the various embodiments described in the present application.

As shown in FIG. 6, in some embodiments, a system 300 can be embodied as any device for searching for a hosted application in the embodiments as described above. In some embodiments, the system 300 may comprise one or more computer-readable media having instructions (e.g., a system memory or a NVM/storage device 320) and one or more processors coupled with the one or more computer-readable media and configured to execute the instructions to implement devices, and to perform the actions described in the present application (e.g., processor(s) 305).

For one embodiment, a system control device 310 may comprise any suitable interface controller for providing any suitable interface for at least one of the processor(s) 305 and/or any suitable device or component in communication with the system control device 310.

The system control device 310 may comprise a memory controller device 330 for providing interface(s) for a system memory 315. The memory controller device 330 may be a hardware device, a software device and/or a firmware device.

The system memory 315 may be used to load and store data and/or instructions for the system 300 for example. For one embodiment, the system memory 315 may comprise any suitable volatile memory (e.g., a suitable DRAM). In some embodiments, the system memory 315 may comprise a double-data-rate fourth generation synchronous dynamic random access memory (DDR4SDRAM).

For one embodiment, the system control device 310 may comprise one or more input/output (I/O) controllers for providing interface(s) to the NVM/storage device 320 and the communication interface(s) 325.

For example, the NVM/storage device 320 may be used to store data and/or instructions. The NVM/storage device 320 may comprise any suitable non-volatile memory (e.g., a flash memory) and/or may comprise any suitable non-volatile storage device(s) (e.g., one or more hard disk drives (HDD), one or more compact disc (CD) drives and/or one or more digital video disc (DVD) drives).

The NVM/storage device 320 may comprise storage resources that are physically part of a device where the system 300 is installed, or it may be accessed by the device but need not to be part of the device. For example, the NVM/storage device 320 may be accessed via the communication interface(s) 325 through a network.

The communication interface(s) 325 may provide interface(s) for the system 300 to communicate through one or more networks and/or with any other suitable devices. The system 300 may communicate with one or more components of a wireless network wirelessly according to any of one or more wireless network standards and/or protocols.

For one embodiment, at least one of the processor(s) 305 may be packaged logically with one or more controllers of the system control device 310 (e.g., the memory controller device 330). For one embodiment, at least one of the processor(s) 305 may be packaged logically with one or more controllers of the system control device 310 to form a system in package (SiP). For one embodiment, at least one of the processor(s) 305 may be integrated logically with one or more controllers of the system control device 310 on a same mold. For one embodiment, at least one of the processor(s) 305 may be integrated logically with one or more controllers of the system control device 310 on a same mold to form a system on chip (SoC).

In various embodiments, the system 300 may be but is not limited to servers, workstations, desktop computing devices or mobile computing devices (e.g., laptop computing devices, hand-held computing devices, tablets, netbooks, etc.). In various embodiments, the system 300 may have more or fewer components and/or different architectures. For example, in some embodiments, the system 300 comprises one or more cameras, keyboards, liquid crystal display (LCD) screens (comprising touch-screen displays), non-volatile memory ports, multiple antennas, graphics chips, application specific integrated circuits (ASICs) and speakers.

It should be noted that the present application can be implemented in software and/or a combination of software and hardware, for example, by using an application specific integrated circuit (ASIC), a general purpose computer, or any other similar hardware device. In one embodiment, the software program of the present application can be executed by a processor to implement the steps or functions described above. Likewise, the software programs (including related data structures) of the present application can be stored in a computer-readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application can be embodied as a computer program product, such as computer program instructions, when executed by a computer, can invoke or provide a method in accordance with the present application. In one embodiment, computer program instructions exist in a computer-readable medium in a form of including, but not limited to, a source file, an executable file, an installation package file, and the like. Correspondingly, the manner in which a computer program instruction is executed by a computer includes, but is not limited to, the computer directly executing the instruction, or the computer compiling the instruction and then executing the corresponding compiled program, or the computer reading and executing the instruction, or the computer reading and installing the instruction and then executing the corresponding post-installation program. Here, the computer-readable medium can be any available computer-readable storage medium or communication medium that can be accessed by a computer.

Communication medium includes medium by which communication signals which include, for example, computer-readable instructions, data structures, program devices, or other data, are transmitted from one system to another. Communication medium can include guided transmission medium (such as cables and wires (e.g., fiber optics, coaxial, etc.)) and wireless (non-conductive transmission) medium that can propagate energy waves, such as sound, electromagnetic, RF, microwave, and infrared. Computer readable instructions, data structures, program devices or other data may be embodied, for example, as a modulated data signal in a wireless medium, such as a carrier wave or a similar mechanism such as being embodied as part of a spread spectrum technology. The term “modulated data signal” refers to a signal whose one or more characteristics are altered or set by encoding information in the signal. Modulation can be analog, digital, or can be hybrid modulation techniques.

By way of example and not limitation, computer-readable storage medium may include volatile and non-volatile, removable and non-removable medium implemented by any method or technology used to store information such as computer readable instructions, data structures, program devices or other data. For example, computer-readable storage medium includes, but is not limited to, volatile memory such as random access memory (RAM, DRAM, SRAM); and non-volatile memory such as flash memory, various read-only memories (ROM, PROM, EPROM, EEPROM), magnetic and ferromagnetic/ferroelectric memory (MRAM, FeRAM); and magnetic and optical storage devices (hard disk, cassette, CD, DVD); or other existing or known medium or any medium to be developed in the future that can store computer-readable information/data for use by computer systems.

Herein, an embodiment in accordance with the present application includes an apparatus including a memory for storing computer program instructions and a processor for executing program instructions, and when the computer program instructions are executed by the processor, triggering the apparatus to operate the above mentioned methods in accordance with various embodiments of the present application.

It is apparent that the present application is not limited to the details of the above-mentioned exemplary embodiments, and the present application can be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. Units or means stated in the apparatus claims may also be implemented by one unit or means by means of software or hardware. The terms first and second are used to represent names, and are not used to represent any particular order.

What is claimed is:

1. A method for searching for a hosted application at a first network device, the method comprising:
establishing or updating a hosted application index information library for a plurality of hosted applications, wherein the plurality of hosted applications are stored or registered at the first network device, and wherein the hosted application index information library comprises a plurality of hosted application records, and each of the hosted application records corresponds to one of the plurality of hosted applications and comprises hosted application information and an index field of the hosted application;
receiving a hosted application search request transmitted by a user equipment;
searching for a match in the hosted application index information library according to the hosted application search request to obtain information on one or more target hosted applications which match the hosted application search request; and
returning information on at least one of the one or more target hosted applications to the user equipment.

2. The method according to claim 1, wherein establishing or updating the hosted application index information library for the plurality of hosted applications, wherein the plurality of hosted applications are stored or registered at the first network device, and wherein the hosted application index information library comprises the plurality of hosted application records, and each of the hosted application records corresponds to one of the plurality of hosted applications and comprises the hosted application information and the index field of the hosted application, comprising:
for the plurality of hosted applications stored or registered at the first network device, obtaining access data information from a second network device corresponding to each of the hosted applications through a predetermined data access interface; and
establishing or updating the hosted application index information library for the plurality of hosted applications according to the access data information, wherein the hosted application index information library comprises a plurality of hosted application records, and each of the hosted application records corresponds to one of the plurality of hosted applications and comprises hosted application information and an index field of the hosted application.

3. The method according to claim 2, wherein establishing or updating the hosted application index information library for the plurality of hosted applications according to the access data information, wherein the hosted application index information library comprises the plurality of hosted application records, and each of the hosted application records corresponds to one of the plurality of hosted applications and comprises the hosted application information and the index field of the hosted application, comprising:
when a hosted application corresponding to the access data information has a corresponding hosted application record in the hosted application index information library, adding description keywords corresponding to the access data information to the index field in the hosted application record; otherwise,
creating a corresponding hosted application record for the hosted application corresponding to the access data information in the hosted application index information library, wherein the hosted application record comprises hosted application information and an index field of the hosted application, and wherein the index field comprises description keywords corresponding to the access data information.

4. The method according to claim 2, wherein the hosted application information comprises identification information and/or the access data information on the corresponding hosted application.

5. The method according to claim 1, wherein establishing or updating the hosted application index information library for the plurality of hosted applications, wherein the plurality of hosted applications are stored or registered at the first network device, and wherein the hosted application index information library comprises the plurality of hosted application records, and each of the hosted application records corresponds to one of the plurality of hosted applications and comprises the hosted application information and the index field of the hosted application, comprising:
for the plurality of hosted applications stored or registered at the first network device, transmitting one or more pieces of search request information to a second network device corresponding to each of the hosted applications through a predetermined search interface, and receiving search response information returned by the second network device; and
establishing or updating the hosted application index information library for the plurality of hosted applications according to the search response information, wherein the hosted application index information library comprises the plurality of hosted application records, and each of the hosted application records corresponds to one of the plurality of hosted applications and comprises hosted application information and an index field of the hosted application.

6. The method according to claim 5, wherein establishing or updating the hosted application index information library for the plurality of hosted applications according to the search response information, wherein the hosted application index information library comprises the plurality of hosted application records, and each of the hosted application records corresponds to one of the plurality of hosted applications and comprises the hosted application information and the index field of the hosted application, comprising:
when a hosted application corresponding to the search response information has a corresponding hosted application record in the hosted application index information library, adding search keywords corresponding to the search request information and/or description keywords corresponding to the search response information to the index field in the hosted application record; otherwise,
creating a corresponding hosted application record for the hosted application corresponding to the access data information in the hosted application index information library, wherein the hosted application record comprises hosted application information and an index field of the hosted application, and wherein the index field comprises the search keywords corresponding to the search request information and/or the description keywords corresponding to the search response information.

7. The method according to claim 5, wherein the hosted application information comprises identification information and/or the search response information on the corresponding hosted application.

8. A device for searching for a hosted application, the device comprising:
a processor; and
a memory arranged to store computer executable instructions, wherein the executable instructions, when executed, cause the processor to:
establish or update a hosted application index information library for a plurality of hosted applications, wherein the plurality of hosted applications are stored or registered at the first network device, and wherein the hosted application index information library comprises a plurality of hosted application records, and each of the hosted application records corresponds to one of the plurality of hosted applications and comprises hosted application information and an index field of the hosted application;
receive a hosted application search request transmitted by a user equipment;
search for a match in the hosted application index information library according to the hosted application search request to obtain information on one or more target hosted applications which match the hosted application search request; and
return information on at least one of the one or more target hosted applications to the user equipment.

9. A computer readable medium comprising instructions, wherein the instructions, when executed, cause a system to:
establish or update a hosted application index information library for a plurality of hosted applications, wherein the plurality of hosted applications are stored or registered at the first network device, and wherein the hosted application index information library comprises a plurality of hosted application records, and each of the hosted application records corresponds to one of the plurality of hosted applications and comprises hosted application information and an index field of the hosted application;
receive a hosted application search request transmitted by a user equipment;
search for a match in the hosted application index information library according to the hosted application search request to obtain information on one or more target hosted applications which match the hosted application search request; and
return information on at least one of the one or more target hosted applications to the user equipment.
